(19) United States
(12) Patent Application Publication
(10) Pub. No.: US 2024/0301940 A1
(43) Pub. Date: Sep. 12, 2024

(54) DRIVE UNIT

(71) Applicant: fischer automotive systems GmbH & Co. KG, Horb a.N. (DE)

(72) Inventor: Ulf-Lothar BASTIAN, Pfalzgrafenweiler (DE)

(21) Appl. No.: 18/440,375

(22) Filed: Feb. 13, 2024

(30) Foreign Application Priority Data
Mar. 6, 2023 (DE) 10 2023 105 484.8
Aug. 7, 2023 (DE) 10 2023 120 922.1

(51) Int. Cl. F16H 3/40; F16H 63/34

(52) U.S. Cl. CPC F16H 3/40; F16H 63/34

(57) ABSTRACT

A drive unit includes a wheel distribution gear mechanism for pivoting, for example, blades of an air vent for guiding an air current out of the air vent into a passenger compartment of a motor vehicle. So as to be able to determine a rotational position of an output wheel of the wheel distribution gear mechanism, for example after a power failure, without a sensor, the invention provides a non-rotation block, which, when the wheel distribution gear mechanism is rotationally driven, reaches a blocking position in which this blocks the output wheel in a defined rotational position to prevent further rotation.

### CROSS-REFERENCE TO RELATED APPLICATION

This application claims priority under 35 USC § 119 to German Application Nos. 10 2023 105 484.8, filed Mar. 6, 2023, and 10 2023 120 922.1, filed Aug. 7, 2023, the entire disclosures of which are incorporated herein by reference.

### TECHNICAL FIELD OF THE INVENTION

The invention relates to a drive unit and an air vent including the drive unit.

### DESCRIPTION OF THE RELATED ART

The international patent application WO 2020/172098 A1 describes a drive unit including an electric motor and a gear wheel distribution gear mechanism, via which two outputs can be rotationally driven by way of the electric motor as a function of the direction of rotation. The gear wheel distribution gear mechanism includes a drive wheel, which is rotationally fixed on a motor shaft of the electric motor, two output wheels spaced equidistantly apart from the motor shaft, which are offset from one another in a circumferential direction of the motor shaft, and two coaxial intermediate wheels that are rotationally fixed with respect to one another, of which a larger intermediate wheel always meshes with the drive wheel, and a smaller intermediate wheel selectively meshes with one of the two output wheels. The two intermediate wheels are rotatably mounted on a pivoting lever, which can be pivoted about the motor shaft of the electric motor, wherein a brake transmits torque from the motor shaft to the pivoting lever. As a result, the pivoting lever is pivoted during rotation of the motor shaft in a first direction of rotation so that the smaller intermediate wheel meshes with one of the two output wheels. When the motor shaft rotates oppositely in an opposite, second direction of rotation, the pivoting lever pivots in an opposite direction until the smaller intermediate wheel meshes with the other output wheel. In this way, the one output wheel is driven when the motor shaft of the electric motor is rotated in the first direction of rotation, and the other output wheel is driven in the opposite direction of rotation when the motor shaft is rotated in the opposite, second direction of rotation.

### SUMMARY OF THE INVENTION

It is the object of the invention to provide a drive unit including a wheel distribution gear mechanism, in which a rotational position of an output wheel can be determined, for example after a power failure.

The drive unit according to the invention includes a wheel distribution gear mechanism including a drive wheel, a first intermediate wheel, and a first output wheel, which can be rotationally driven by way of the drive wheel via the first intermediate wheel. The drive unit does not have to comprise any further output wheels than the first output wheel, but can comprise one or more further output wheels. Likewise, it is possible for more than one intermediate wheel to be present, via which the output wheels can be rotationally driven by the drive wheel. While more than one drive wheel is not provided, this is also not precluded.

The wheel distribution gear mechanism is preferably designed as a gear wheel distribution gear mechanism including gear wheels meshing with one another. However, a friction wheel distribution gear mechanism including friction wheels rolling on or against one another is also possible.

The drive unit includes a first guide for the first intermediate wheel, which movably guides the first intermediate wheel on a circular path that is concentric with respect to an axis of rotation of the drive wheel. In the process, an axis of rotation of the first intermediate wheel, in particular, moves on the circular path, wherein the first intermediate wheel can additionally rotate about the axis of rotation thereof. The first intermediate wheel is in contact with the drive wheel at all points of the guide and is rotationally driven by the drive wheel during rotation of the drive wheel. Driving the drive wheel in a first direction of rotation moves the first intermediate wheel along the first guide, in a circumferential direction of the drive wheel, into a first driving position, in which the first intermediate wheel is in contact not only with the drive wheel, but also with the first output wheel, so that the drive wheel drives the first intermediate wheel and, via the first intermediate wheel, the first output wheel so as to rotate. Driving in the reverse direction of rotation brings the first intermediate wheel out of contact with the first output wheel so that the first output wheel is not driven via the first intermediate wheel.

The drive unit according to the invention furthermore includes a first non-rotation block for the first output wheel, which, during the rotation in the first direction of rotation, is moved into a blocking position by the drive wheel, in which the first non-rotation block blocks the first output wheel, in a defined rotational position, to prevent further rotation. For example, the first output wheel includes a stop that, in the defined rotational position of the first output wheel, strikes against the first non-rotation block when the first non-rotation block is in the blocking position, whereby the first non-rotation block holds the first output wheel to prevent further rotation. The first non-rotation block allows the first output wheel to be rotated from any rotational position, which does not have to be known, into the defined rotational position, whereupon the rotational position of the first output wheel is known. From the defined rotational position, the output wheel can be rotated into a, or into any, desired rotational position by being rotated by an appropriate angle of rotation. No rotation angle sensor, rotational position sensor or the like is necessary for rotating the first output wheel into the defined rotational position and, where necessary, out of the defined rotational position into a, or into any, desired rotational position. The fact that the defined rotational position has been reached can be recognized, for example, based on the profile of the current at the drive motor.

In a release position, in embodiments of the invention, the first non-rotation block can be moved in a second direction of rotation, which is opposite the first direction of rotation, by a rotation of the drive wheel. Another option is to design the first non-rotation block in the manner of a pawl of a freewheel so that the first non-rotation block only blocks the first output wheel, in the defined rotational position, to prevent a rotation in the first direction of rotation, while a rotation of the drive wheel in the second direction of rotation is possible. In the release position, the first drive wheel can be rotated beyond the defined rotational position in the first direction of rotation.

One embodiment of the invention provides a pivotable mounting of the first non-rotation block, for example similarly to an escapement or an anchor escapement of a mechanical clock. In particular, a pivot axis of the first non-rotation block is identical to the axis of rotation of the drive wheel. However, embodiments in which the pivot axis of the first non-rotation block is spaced apart from the axis of rotation of the drive wheel are also possible. A rotation of the drive wheel in the first direction of rotation pivots the first non-rotation block into the blocking position, and a rotation of the drive wheel in the opposite, second direction of rotation preferably pivots the first non-rotation block out of the blocking position or into the release position. The pivot mounting is, in particular, configured, for example by way of a brake, such that the inertia of the non-rotation block is greater than that of the intermediate wheel. This means the following. When the first output wheel has reached the defined rotational position and is blocked by the non-rotation block to prevent further rotation, the non-rotation block can be released by rotation in the second direction of rotation. However, the contact between the first intermediate wheel and the first output wheel is released at the same time, so that the same remains in the defined rotational position. When the direction of rotation changes again, the first intermediate wheel makes contact with the first output wheel and starts to rotate the same before the non-rotation block is pivoted back into the blocking position. The blocking of the output wheel can thus be overcome by back and forth rotation, due to the inertia of the non-rotation block.

In a preferred embodiment of the invention, the wheel distribution gear mechanism includes a second output wheel, which can likewise be rotationally driven via the first intermediate wheel or via a second intermediate wheel. The invention does not preclude more than two output wheels and intermediate wheels. According to one embodiment of the invention, the first guide movably guides the first intermediate wheel both into the first driving position, in which this drives the first drive wheel, and into a second driving position, in which the first intermediate wheel rotationally drives the second output wheel. The rotation of the drive wheel in the first direction of rotation moves the first intermediate wheel into the first driving position so that the drive wheel rotationally drives the first output wheel via the first intermediate wheel. The opposite rotation of the drive wheel in the second direction of rotation moves the first intermediate wheel into the second driving position in which the drive wheel rotationally drives the second output wheel via the intermediate wheel.

Another embodiment of the invention provides a second intermediate wheel for rotationally driving the second output wheel. In this embodiment of the invention, the drive unit or the wheel distribution gear mechanism includes a second guide for the second intermediate wheel, which movably guides the second intermediate wheel on a circular path that is concentric with respect to the axis of rotation of the drive wheel, so that the second intermediate wheel, similarly to the first intermediate wheel, is in contact with the drive wheel at all points of the guide, and is rotationally driven by the drive wheel during rotation of the drive wheel. A rotation of the drive wheel in the second direction of rotation moves the second intermediate wheel into a second driving position in which the second intermediate wheel rotationally drives the second output wheel. A rotation of the drive wheel in the first direction of rotation moves the second intermediate wheel into an idle position in which the second intermediate wheel does not drive the second output wheel.

A refinement of the invention provides a non-rotation block, which blocks the second output wheel, in a defined rotational position, to prevent further rotation. During the rotation in the second direction of rotation, the first non-rotation block can block the second output wheel, in the defined rotational position, to prevent further rotation, or a second non-rotation block is present for the second output wheel, which, in the second direction of rotation of the drive wheel, blocks the second output wheel, in the defined rotational position, to prevent further rotation.

It is possible, for example, to rotatably mount the first intermediate wheel, or the intermediate wheels, for the circular arc guidance thereof, on an intermediate wheel carrier, which is pivotably mounted about the axis of rotation of the drive wheel, serving as the pivot axis, at a distance with respect to an axis of rotation of the intermediate wheel or intermediate wheels. It is possible that one intermediate wheel carrier is present for both, several, or all intermediate wheels, or the drive unit includes an intermediate wheel carrier for each intermediate wheel. One embodiment of the invention provides a circular arc guide, serving as a guide or as guides for the first intermediate wheel or for the intermediate wheels, which movably guides or guide the intermediate wheel or the intermediate wheels on the circular paths that are concentric with respect to the axis of rotation of the drive wheel.

Within the scope of the invention, it is also possible to rotationally drive the output wheel, or the output wheels, via a freewheel for each output wheel. The freewheels can replace the intermediate wheel, or the intermediate wheels, or the freewheels include the intermediate wheels. For example, an intermediate wheel that can be rotationally driven by way of the drive wheel can be connected via a freewheel, in a direction of rotation, to an intermediate wheel driving the associated output wheel in the one direction of rotation.

An air vent for supplying air to a passenger compartment of a motor vehicle, includes a drive unit of the type described above for pivoting the air guide elements thereof, in particular the blades thereof and/or the air volume control elements thereof, in particular of a damper.

The features and feature combinations, designs, and embodiments of the invention mentioned above in the description, and the features and feature combinations mentioned hereafter in the description of the figure and/or shown in a figure, can be used not only in the respective indicated or illustrated combination, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment, but an essentially arbitrary portion of the characterizing features of the exemplary embodiment, are possible.

### BRIEF DESCRIPTION OF THE DRAWING

The invention will be described in more detail hereafter based on an exemplary embodiment shown in the drawing.

FIG. 1 shows a drive unit according to the invention. The drawing is a schematic and simplified illustration to provide an understanding of and to describe the invention.

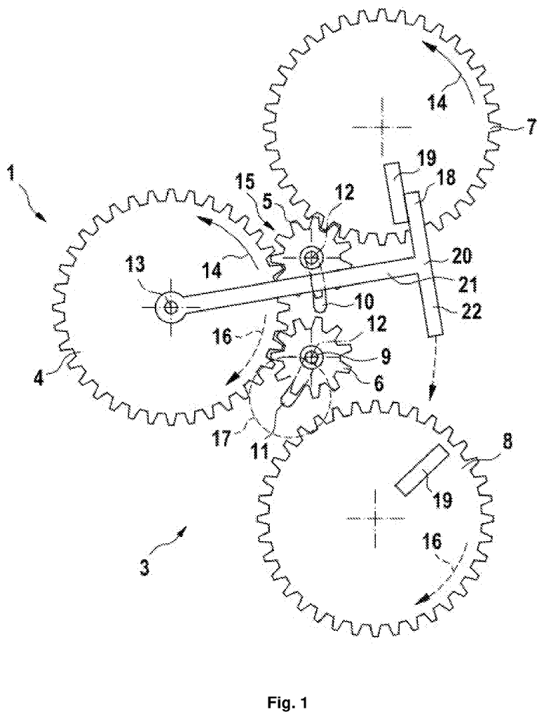

### DETAILED DESCRIPTION OF THE EMBODIMENT(S)

The drive unit 1 according to the invention shown in the drawing is provided for rotationally driving two outputs by way of a drive, in the exemplary embodiment by way of an electric motor, as a function of the direction of rotation. In the exemplary embodiment, the electric motor is a gear motor including a flange-mounted gear mechanism, which is concealed by a drive wheel 4 and therefore not visible. The invention is not limited to a driving operation by way of an electric motor.

The drive unit 1 includes a wheel distribution gear mechanism 3 including a drive wheel 4, a first intermediate wheel 5, a second intermediate wheel 6, a first output wheel 7, and a second output wheel 8. However, embodiments of the invention including only one intermediate wheel 5 (or 6) and/or including only one output wheel 7 (or 8) are also possible. In the exemplary embodiment, the wheel distribution gear mechanism 3 is a gear wheel distribution gear mechanism, and the drive wheel 4, the two intermediate wheels 5, 6, and the two output wheels 7, 8 are spur gear wheels having parallel axes of rotation, with other gear wheels and/or axes of rotation that are oblique with respect to one another also being possible (not shown). Embodiments of the invention that include a friction wheel distribution gear mechanism having friction wheels that roll on one another, or against one another with the circumferences thereof, serving as the wheel distribution gear mechanism 3 are also possible (not shown).

The two intermediate wheels 5, 6 are disposed offset from one another in a circumferential direction with respect to the drive wheel 4 on a circumference of the drive wheel 4, so that the two intermediate wheels 5, 6 mesh with the drive wheel 4, and both intermediate wheels 5, 6 can be rotationally driven by way of the drive wheel 4.

The two intermediate wheels 5, 6 are movably guided on circular arcs, which are concentric with respect to the drive wheel 4. The movability of the intermediate wheels 5, 6 is limited in the circumferential direction of the drive wheel 4. The two intermediate wheels 5, 6 include intermediate wheel shafts, which can be rotated in grooves and are guided so as to be movable toward the groves, and which are rotatably mounted. The grooves extend concentrically with respect to the drive wheel 4, in a circular arc shape around the drive wheel 4, with lengths of the grooves being limited in the circumferential direction of the drive wheel 4. The grooves form a first guide 10 for the first intermediate wheel 5, and a second guide 11 for the second intermediate wheel 6. Both guides 10, 11 are circular arc guides.

The two intermediate wheels 5, 6 can have differing diameters, and the guides 10, 11 thereof can have differing radii and radial distances with respect to the axis of rotation 13 of the drive wheel 4. In the exemplary embodiment, the two intermediate wheels 5, 6 have the same diameter, and the guides 10, 11 thereof have the same radius and radial distance with respect to the axis of rotation 13 of the drive wheel 4.

An intermediate wheel carrier, for example, on which the intermediate wheels 5, 6 are mounted so as to be rotatable about the axes of rotation 12 thereof, may also be used for the circular arc guidance of the intermediate wheels 5, 6, wherein the intermediate wheel carrier is mounted, for example on the electric motor, so as to be pivotable about the axis of rotation 13 of the drive wheel 4 (not shown). The drive unit 1 or the wheel distribution gear mechanism 3 can also include such an intermediate wheel carrier for each intermediate wheel 5, 6.

The two output wheels 7, 8, which are likewise offset from one another in the circumferential direction of the drive wheel 4, are disposed at a radial distance with respect to the drive wheel 4 which is smaller than the diameter of the intermediate wheels 5, 6. The two output wheels 5, 6 do not mesh with the drive wheel 4. In the exemplary embodiment, the two intermediate wheels 5, 6 are located between the two output wheels 7, 8; however, the intermediate wheels 5, 6 can also be disposed outside the two output wheels 7, 8 (not shown).

During rotation of the drive wheel 4, the two intermediate wheels 5, 6 are rotationally driven and moved in the guides 10, 11 thereof in the direction of rotation of the drive wheel 4. In the process, an intermediate wheel 5, 6 approaches one of the two output wheels 7, 8 and reaches a driving position, in which the intermediate wheel 5, 6 meshes with the one output wheel 7, 8, so that the drive wheel 4 rotationally drives the one output wheel 7, 8 via the one intermediate wheel 5, 6.

The other intermediate wheel 5, 6 moves away from the other output wheel 7, 8 and assumes an idle position, in which the other intermediate wheel 7, 8 does not mesh with the other output wheel 5, 6. In this position, the other intermediate wheel 7, 8 is not driven by the drive wheel 4.

During rotation of the drive wheel 4 in a direction of rotation, which is referred to as the first direction of rotation 14 here, the first intermediate wheel 5 reaches a first driving position in which this meshes with the first output wheel 7 so that the first output wheel 7 is rotationally driven. The first direction of rotation 14 is shown with a circular arrow having a solid line in the drawing. The second intermediate wheel 5 reaches or is in the idle position, meshing neither with the first output wheel 7, nor with the second output wheel 8. The second output wheel 8 is thus not driven. The drawing shows the first intermediate wheel 5 in the first driving position 15 and the second intermediate wheel 6 in the idle position.

During an opposite rotation of the drive wheel 4 in a second direction of rotation 16, the conditions are reversed. The first intermediate wheel 5 moves away from the first output wheel 7 and reaches an idle position, in which this does not mesh with the first output wheel 7, and in the exemplary embodiment also does not mesh with the second output wheel 8, and the first output wheel 7 is not driven. The second intermediate wheel 6 reaches the second driving position 17, in which this meshes with the second output wheel 8 so that the drive wheel 4 rotationally drives the second output wheel 8 via the second intermediate wheel 6. The second direction of rotation 16 is shown with a circular arrow having a dotted line in the drawing, and the second driving position 17 of the second intermediate wheel 6 is shown with a circle having a dotted line.

An embodiment (not shown) of the wheel distribution gear mechanism 3 including only one intermediate wheel (for example 5), which, during the rotation of the drive wheel 4 in the first direction of rotation 14, reaches the first driving position 15 in which this meshes with the first output wheel 7, is also possible. During rotation of the drive wheel 4 in the second direction of rotation 16, the, in this case, only one or first intermediate wheel 5 reaches the second driving position 17 in which this meshes with the second output wheel 8. In this embodiment, the length of the first guide 10 of the first intermediate wheel 5 is such that the first intermediate wheel 5 can reach both the first driving position 15, in which the first intermediate wheel 5 meshes with the first output wheel 7, and the second driving position 17, in which the first intermediate wheel 5 meshes with the second output wheel 8.

The wheel distribution gear mechanism 3 of the drive unit 1 according to the invention includes a first non-rotation block 18 for the first output wheel 7 which, in a blocking position, blocks the first output wheel 7 in a defined rotational position of the first output wheel 7 to prevent further rotation. For this purpose, the first output wheel 7 includes a stop 19 that, during the rotation of the output wheel 7, strikes against the first non-rotation block 18 when the first non-rotation block 18 is in the blocking position. The stop 19 defines the defined rotational position of the first output wheel 7. The drawing shows the first non-rotation block 18 in the blocking position, and the first output wheel 7 in the defined rotational position.

In the exemplary embodiment, the drive unit 1 or the wheel distribution gear mechanism 3 includes a T-shaped blocking lever 20, the shank 21 of which is mounted so as to be pivotable about the axis of rotation 13 of the drive wheel 4. A pivot axis of the blocking lever 20 can also be spaced radially apart from the axis of rotation 13 of the drive wheel 4. Friction between a shaft of the drive wheel 4 and/or between the drive wheel 4 and the shank 21 of the blocking lever 20 causes the blocking lever 20 to pivot during rotation of the drive wheel 4 in the direction of rotation.

A crosshead of the T-shaped blocking lever 20 forms the first non-rotation block 18 and a second non-rotation block 22, and more particularly, a half of the crosshead of the T-shaped blocking lever 20 which faces the first output wheel 7 forms the first non-rotation block 18, and a half of the crosshead which faces the second output wheel 8 forms the second non-rotation block 22. The crosshead, and thus also the two non-rotation blocks 18, 22, are radially spaced apart from the axis of rotation 13 of the drive wheel 4 by approximately the same distance as the axes of the two output wheels 7, 8. The distance is slightly larger in the exemplary embodiment.

When the drive wheel 4, during rotation in the first direction of rotation 14, pivots the blocking lever 20 toward the first output wheel 7, the first non-rotation block 18 reaches the blocking position in a circular path on which the stop 19 of the first output wheel 7 moves during rotation of the first output wheel 7. As a result of the rotation of the first output wheel 7, the stop 19 strikes against the first non-rotation block 18, which thus blocks the first output wheel 7 to prevent further rotation.

The blocking of the first output wheel 7 to prevent further rotation, via the first intermediate wheel 5, also blocks the drive wheel 4 to prevent further rotation in the first direction of rotation 14. As a result of the standstill of the drive wheel 4, it is possible to determine the rotational position of the first output wheel 7 which is defined by the stop 19 of the first output wheel 7 striking against the first non-rotation block 18 in the blocking position. In this way, the invention allows the first output wheel 7 to be rotated from any rotational position, which does not have to be known, into the defined rotational position. Proceeding from the defined rotational position, the first output wheel 7 can be rotated into a desired rotational position by accordingly further rotating the drive wheel 4.

Before that, the first non-rotation block 18 must be moved into a release position, out of the circular path of the stop 19 of the first output wheel 7. For this purpose, the drive wheel 4 is rotated in the second direction of rotation 16, whereby the first non-rotation block 18 is moved away from the first drive wheel 4, and out of the circular path of the stop 19 of the first output wheel 4. At the same time, the first intermediate wheel 6 reaches the idle position. Thereafter, the drive wheel 4 can be rotated in the first direction of rotation 14 again and rotationally drives the first output wheel 7 again via the first intermediate wheel 6. Before the first non-rotation block 18 reaches the blocking position again in the circular path of the stop 19 of the first output wheel 7, the stop 19 has overcome the first non-rotation block 18, whereby a full revolution of the first output wheel 7 is possible, before the stop 19 thereof strikes against the first non-rotation block 18 in the blocking position again, which blocks the first output wheel 7 in the rotational position, which is established by the stop 19 striking against the first non-rotation block 18, to prevent further rotation. The non-rotation block 18 thus has a certain inertia compared to the movement of the first intermediate wheel 6, which reaches the first driving position 15 from the idle position faster than the non-rotation block 18 returns into the blocking position.

This process of bringing the first non-rotation block 18 out of the blocking position by rotating the drive wheel 4 in the second direction of rotation 16, and subsequently rotating the first output wheel 7 a full revolution in the first direction of rotation 14, can be repeated any number of times.

The defined rotational position of the first output wheel 7 can be determined, for example, by measuring a motor current of the electric motor for driving the drive wheel 4, which increases suddenly when the drive wheel 4 is blocked to prevent further rotation.

When the drive wheel 4 is rotated in the second direction of rotation 16, the drive wheel 4 pivots the blocking lever 20 toward the second output wheel 8, thereby pivoting the second non-rotation block 22 into a blocking position in a circular path of a stop 19 of the second output wheel 8, whereby the second output wheel 8, in the rotational position that is defined by the stop 19 thereof bearing against the second non-rotation block 22 in the blocking position, is blocked to prevent further rotation. The description provided regarding the blocking and release of the first output wheel 17 applies accordingly when the directions of rotation 14, 16 are reversed.

The two non-rotation blocks 18, 22 do not have to be pivotable, but can, for example, also be displaceably guided. Likewise, it is also possible to drive the non-rotation blocks 18, 22 other than by way of friction between the drive wheel 4, or the shaft thereof, and the non-rotation blocks 18, 22.

The drive unit 1 according to the invention can be used, for example, to pivot blades or, generally speaking, air guide elements, of an air vent, which is not shown. The air vent is used, for example, to supply air to a passenger compartment in a motor vehicle. By pivoting the blades or the air guide elements, the air current can be guided through the air vent into the passenger compartment of the motor vehicle. It is also possible to open and close a blocking flap or damper, or the like, or, generally speaking, an air volume control element, of the air vent, which is not shown, using the drive unit 1 according to the invention.

### LIST OF REFERENCE NUMERALS

1 Drive Unit
2 unassigned
3 wheel distribution gear mechanism
4 drive wheel
5 first intermediate wheel
6 second intermediate wheel
7 first output wheel
8 second output wheel
9 intermediate wheel shaft
10 first guide
11 second guide
12 axis of rotation of intermediate wheel
13 axis of rotation of drive wheel
14 first direction of rotation
15 first driving position
16 second direction of rotation
17 second driving position
18 first non-rotation block
19 stop
20 blocking lever
21 shank
22 second non-rotation block

1. A drive unit comprising a wheel distribution gear mechanism comprising a drive wheel, a first intermediate wheel, which is drivingly connected to the drive wheel so that the first intermediate wheel can be rotationally driven by the drive wheel, a first output wheel, which can be rotationally driven by the drive wheel via the first intermediate wheel, a first guide for the first intermediate wheel, which movably guides the first intermediate wheel on a circular path that is concentric with respect to an axis of rotation of the drive wheel so that, in a first driving position of the first intermediate wheel, the first output wheel can be rotationally driven by the drive wheel via the first intermediate wheel and, in a first idle position, the first output wheel is not drivingly connected to the first intermediate wheel, and the drive wheel, during rotation in a first direction of rotation, moves the first intermediate wheel into the first driving position and, during rotation in an opposite, second direction of rotation, into the first idle position, wherein the drive unit comprises a first non-rotation block for the first output wheel which, during the rotation in the first direction of rotation, is moved by the drive wheel into a blocking position, in which the first non-rotation block blocks the first output wheel in a defined rotational position to prevent further rotation.

2. The drive unit according to claim 1, wherein, during rotation in the second direction of rotation, the drive wheel brings the first non-rotation block into an idle position, disengaged from the first output wheel, so that the first output wheel can be rotated in both directions of rotation.

3. The drive unit according to claim 1, wherein the first non-rotation block is pivotably mounted and, during the rotation in the first direction of rotation, is pivoted by the drive wheel into the blocking position and, during the rotation in the second direction of rotation, is pivoted by the drive wheel into the idle position, disengaged from the first output wheel.

4. The drive unit according to claim 1, wherein: the wheel distribution gear mechanism comprises a second output wheel, which can be rotationally driven by the drive wheel via the first intermediate wheel; the first guide also movably guides the first intermediate wheel into a second driving position, in which the second output wheel can be rotationally driven by the drive wheel via the first intermediate wheel; and during the rotation in the second direction of rotation, the drive wheel moves the first intermediate wheel into the second driving position.

5. The drive unit according to claim 1, wherein: the wheel distribution gear mechanism comprises a second intermediate wheel, which is drivingly connected to the drive wheel so that the second intermediate wheel can be rotationally driven by the drive wheel, a second output wheel, which can be rotationally driven by the drive wheel via the second intermediate wheel, and a second guide for the second intermediate wheel, which movably guides the second intermediate wheel on a circular path that is concentric with respect to the axis of rotation of the drive wheel so that, in a second driving position of the second intermediate wheel, the second output wheel can be rotationally driven by the drive wheel via the second intermediate wheel and, in an idle position, the second output wheel is not drivingly connected to the second intermediate wheel; and, during rotation in the second direction of rotation, the drive wheel moves the second intermediate wheel into the second driving position and, during rotation in the first direction of rotation, moves the second intermediate wheel into the idle position.

6. The drive unit claim 1, wherein, during the rotation in the second direction of rotation, the drive wheel moves the first non-rotation block or a second non-rotation block into a second blocking position, in which the first or the second non-rotation block blocks the second output wheel in a defined rotational position to prevent further rotation.

7. The drive unit according to claim 1, wherein the guide has a circular arc guide, which movably guides the intermediate wheel on a circular path that is concentric with respect to the axis of rotation of the drive wheel.

8. The drive unit according to claim 1, wherein the wheel distribution gear mechanism comprises a gear wheel distribution gear mechanism.

9. An air vent, comprising at least one pivotable air guide element, and possibly a pivotable air volume control element, and comprising a drive unit according to claim 4, wherein: a first air guide element of the air vent is drivingly connected to the first output wheel of the wheel distribution gear mechanism of the drive unit so that the first output wheel pivots the first air guide element; and a second air guide element or the air volume control element of the air vent is drivingly connected to the second output wheel of the wheel distribution gear mechanism of the drive unit so that the second output wheel pivots the second air guide element or the air volume control element.
